(19) United States
(12) Patent Application Publication
(10) Pub. No.: US 2006/0124510 A1
(43) Pub. Date: Jun. 15, 2006

(54) Devices, materials and methods for sorting, separating and sizing very small particles

(76) Inventor: Neal Kalechofsky, Stow, MA (US)

Correspondence Address: Todd S. Parkhurst, 30th Floor, 131 South Dearborn St., Chicago, IL, 60603, US

(21) Appl. No.: 10/962,641

(22) Filed: Oct. 12, 2004

(51) Int. Cl. B03B 5/62; B03B 5/66

(52) U.S. Cl. 209/172; 209/158

(57) ABSTRACT

Advice for sorting separating and sizing very small particles is disclosed and claimed. The device comprises a cryogenic chamber within which particle movement, travel and separation can occur; a particle loading chamber for loading particles into the cryogenic chamber; and a particle collector. Also disclosed and claimed is helium, and more specifically helium in its superfluid state, for separating the particles.

### BACKGROUND OF THE INVENTION

Very small particles are used in a wide variety of manufactured products. In many of these products, the particles must be of extremely small size, but the small particles must be as uniform in size as possible. Examples of products containing extremely small particles of uniform size include pharmaceuticals, abrasives, inks, high-performance liquid chromatography columns, foodstuffs, and many others.

Separation of particles by size is a critical step in the production of such particles. Particles having an average size of about 40 microns or larger can be collected by using micromachined filters. To collect, or harvest, particles having an average size smaller than about 40 microns is often accomplished by air classification. Air classification uses Stokes drag to separate particles by size. A particle falling under the influence of gravity (either the earth's gravity or an artificially induced gravitational field such as that provided by a centrifuge) in a viscous fluid medium such as air will have a terminal velocity that is strongly dependent upon the diameter of the falling particle. Differently sized particles fall through air or other viscous fluid media at different rates, thus separating in space and enabling them to be easily harvested by size.

Air classification processes works tolerably well for the separation and harvesting of particle sizes down to about two microns. However, the efficiency of the classification process depends crucially on the properties of the viscous fluid medium through which the particles are sedimenting.

But when the particles to be separated, sized, and harvested have a geometric average diameter of less than about two microns, air classification and other systems are difficult to use. Reasons for this can be inferred from FIG. 1:
1. Terminal velocities for these extremely small particles become very low.
2. Brownian motion begins to dominate particle dynamics.
3. Particle agglomeration due to Van der Waal's attraction between particles begins to retard particle separation.

### OBJECTS OF THE INVENTION

It is accordingly the general object of this invention to provide a device for separating extremely small particles according to their average diameter or size. A related object is to provide such a device which will operate in a relatively rapid and reliable matter.

Another related object of the invention is to utilize a sedimentation medium which will encourage and permit particles of extremely small size to separate and sediment relatively rapidly and in a reliably predictable manner.

Yet another object of the invention is to provide a device for separating extremely small particles which can be operated relatively easily and at relatively small expense.

Although the preferred embodiment described below provides a device for separating particles by size, it is clear that in general the process could be extended to separate particles by shape, mass, density mechanical defect, or any other characteristic which causes some of the particles to fall through a medium faster than other particles.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is a graph showing the relationship of the geometric average diameter of particles falling through a fluid medium of known viscosity, the terminal velocity of those particles, and the Brownian displacement to which those particles are susceptible.

FIG. 2 is a phase diagram of helium.

FIG. 3a is a sketch showing an extremely small particle and the wetting action imposed by a fluid surrounding the particle.

FIG. 3b is a sketch similar to FIG. 3a showing two extremely small particles insulated from one another and deterred from agglomeration by layers of adhered atoms of the medium in which they are immersed.

FIG. 4 is a schematic drawing showing, in sectional aspect, the top of a device for separating, sizing and classifying extremely small particles.

FIG. 5 is a schematic drawing showing, in sectional aspect, the bottom of the device shown in FIG. 4 for separating, sizing and classifying extremely small particles.

FIG. 6 is an image derived from a scanning electronic microscope showing the top layer of a mixture of 7 micron and 2 micron diameter particles prior to sedimentation in superfluid helium.

FIG. 7 is an image derived from a scanning electron microscope showing the top layer of a mixture of 7 micron and 2 micron diameter particles after sedimentation in superfluid helium.

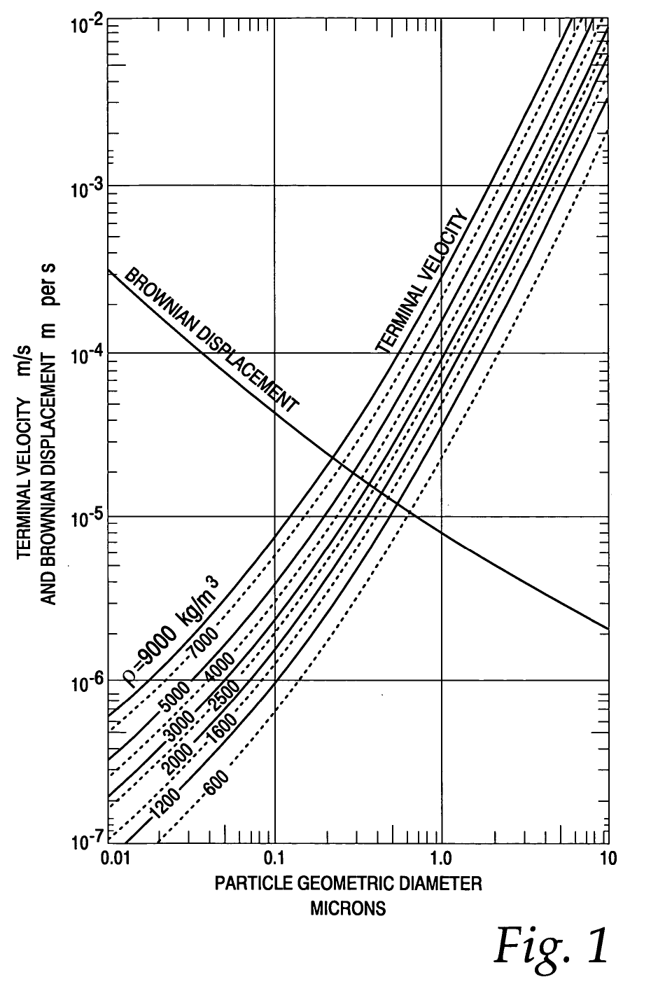

### DETAILED DESCRIPTION

While the invention will be described in connection with certain preferred embodiments and procedures, it will be understood that it is not intended to limit the invention to these embodiments or procedures. On the contrary, it is intended to cover all alternatives, modifications and equivalents as may be included within the spirit and scope of the invention as defined by the appended claims.

To accomplish the above objects, the invention comprises a quantity of low viscosity high wetting parameter fluid; means for injecting the particles to be sorted, separated and sized into that fluid; and means for harvesting at least some of those separated particles from the fluid.

The properties of superfluid helium make it an excellent medium in which to separate small particles. Ordinary liquid helium at 4.2 degrees Kelvin has a viscosity 5.5 times less than that of air at 20 degrees centigrade. A low viscosity medium suggests a relatively high terminal velocity for particles passing through the medium. In addition, if a low temperature can be maintained in the medium, the effect of Brownian diffusion on particle dynamics will be minimized. Furthermore, liquid helium has a very high wetting parameter; that is, helium atoms have a greater affinity for foreign objects than they do for other helium atoms. As a result, and as suggested in FIGS. 3a and 3b, solid particles 10 immersed in liquid helium 12 quickly become insulated from one another in layers 14 of adhered helium atoms that have only a very weak Van der Waals attraction to one another. The layers of helium atoms thus acts as a surfactant to deter particle agglomeration while the particles are immersed in the cold liquid. Accordingly, liquid helium is a good candidate for a better particle sedimentation protocol than protocols currently achievable using air classifying equipment or other currently available techniques.

However, because liquid helium will boil under ordinary conditions, superfluid helium is an even better sedimentation medium. Superfluid helium can be produced relatively simply by lowering the pressure above a container filled with ordinary liquid helium. The physical properties of superfluid helium are so different from ordinary helium liquid helium, or Liquid Helium I, that superfluid helium is considered to be a unique state of matter; it is neither a solid nor liquid nor gas. Either 3He or 4He or a combination of 3He and 4He can be used.

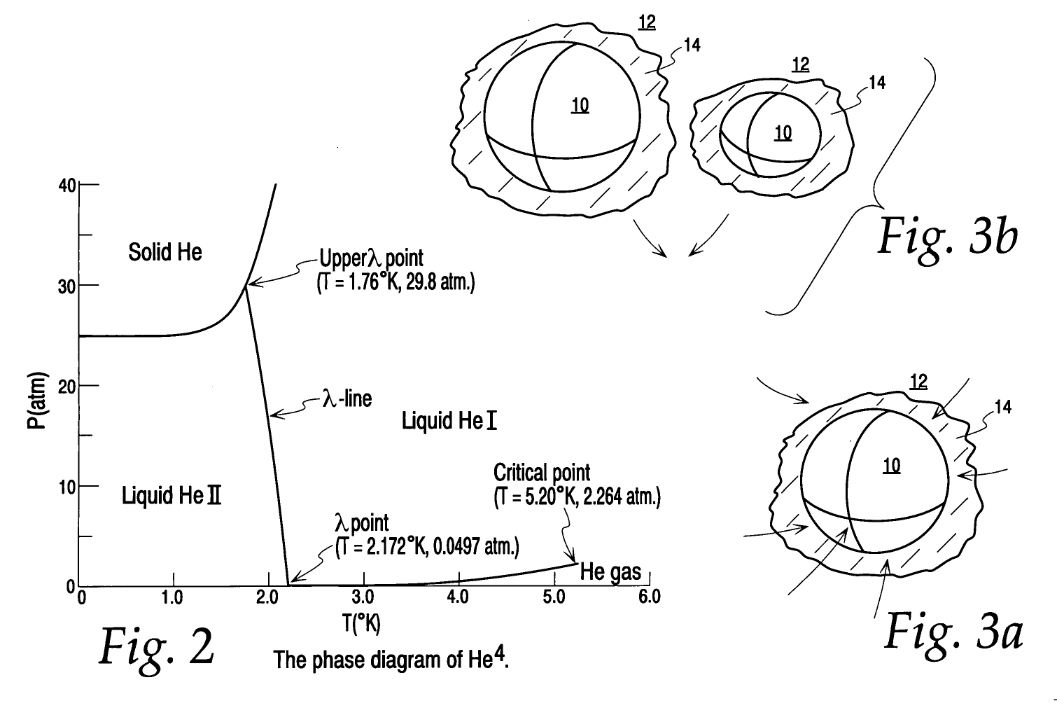

The pressure and temperature constraints for superfluid helium or Liquid Helium II are shown in the phase diagram of FIG. 2. To generalize somewhat, superfluid helium can be produced and maintained at pressures less than 2.5 atmospheres and temperatures below 2 degrees Kelvin. In accordance with the invention, superfluid helium can be used to efficiently, effectively and inexpensively separate and sort extremely small particles.

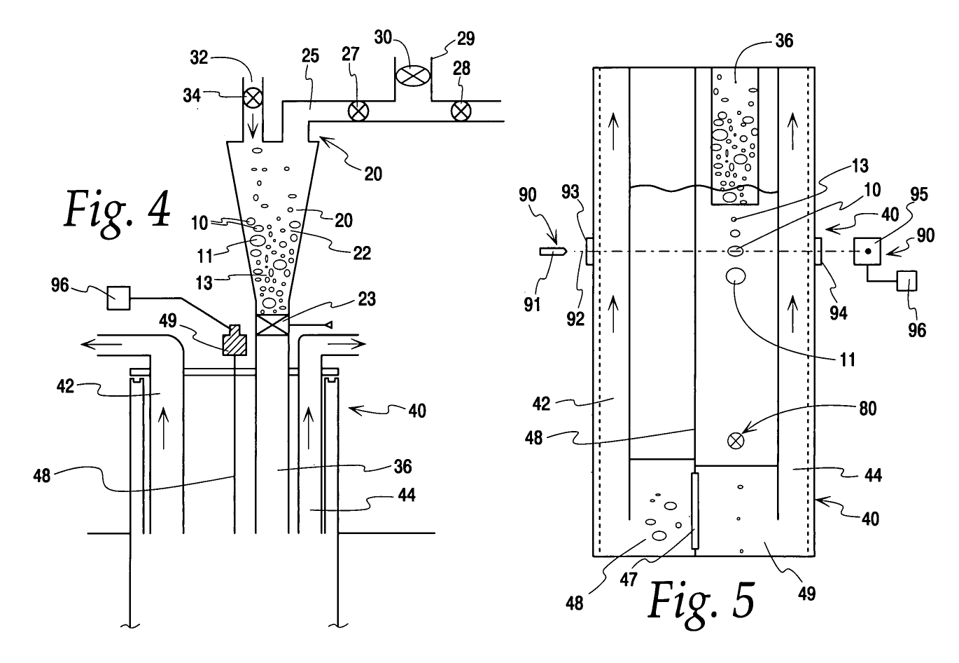

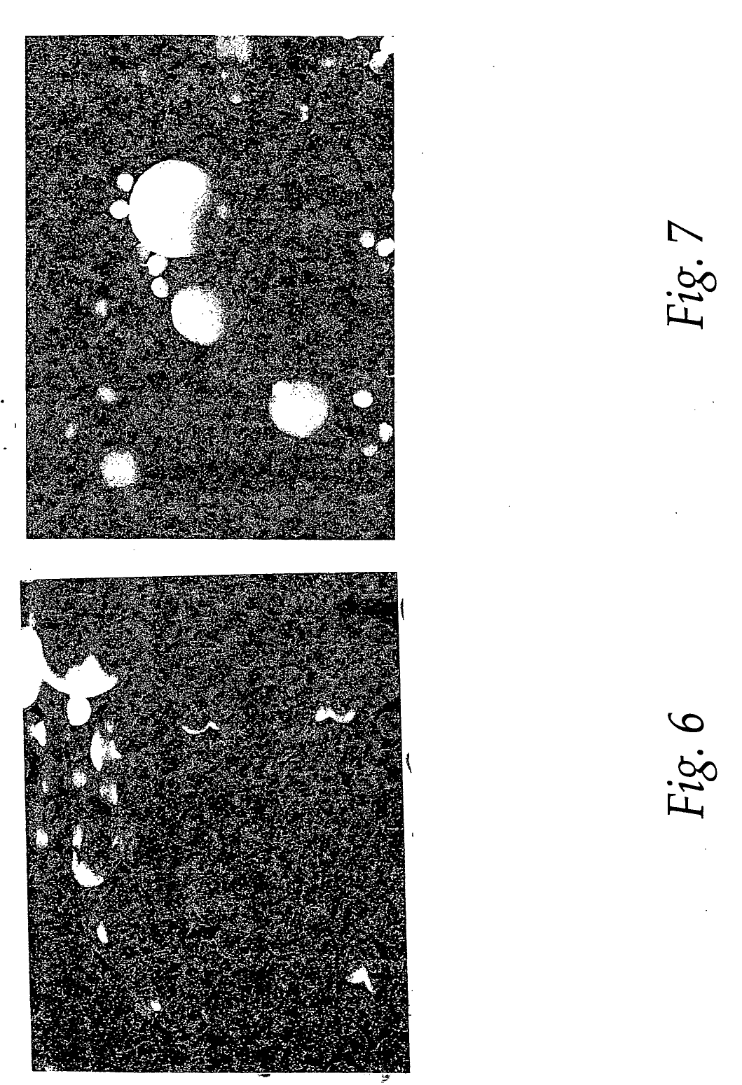

A device for sorting, separating and sizing extremely small particles is suggested schematically in FIGS. 4 and 5. To separate extremely small particles according to their average diameter or size, and to do so in a relatively rapid, reliable yet inexpensive manner in accordance with the invention, the illustrated device comprises, a cryogenic chamber 40 within which particle movement and separation can occur; a loading chamber 20 connected to the cryogenic chamber 40 for loading particles into the cryogenic chamber, and a collector device 80 connected to the cryogenic chamber 40 for collecting at least some of the particles after they have been separated by size.

The closed, gas-tight loading chamber 20 includes a receiver 22 for receiving particles 10, 11 and 13 to be separated and for loading the particles 10, 11 and 13 into the cryogenic chamber 40. A gate valve 23 is interposed between the receiver 22 and the cryogenic chamber 40 for controlling the flow of particles from the loading chamber 20 to the cryogenic chamber 40.

Above or upstream of the receiver 22, a vacuum conduit 25 is connected via appropriate valving 27, 28 to a vacuum or exhaust pump (not shown) for drawing air from the receiver 22. A delivery conduit 29 delivers helium to the receiver 20 when appropriate valving 30, 27 is opened. The particles 10, 11, 14 to be classified, sorted and sized can be delivered from a remote source (not shown) through a conduit 32 and inlet valve 34 to the receiver 22. At appropriate time, the gate valve 23 is opened and the particles flow from the receiver 22 through a delivery conduit 36 extending into the interior of the cryogenic chamber 40 by a sufficient distance so that the particles are deposited within superfluid in the cryogenic chamber 40.

In accordance with one aspect of the invention, the cryogenic chamber is adapted to produce and maintain a column of very low viscosity, high wetting fluid such as superfluid helium 4He. An OptistatSXM Helium bath cryostat can be adapted and used for this purpose. This device is available from Oxford Instruments Superconductivity USA of 130A Baker Avenue Extension, Concord, Mass.

As indicated above, particles falling through the superfluid medium in the cryogenic chamber tend to separate according to their size; larger particles tend to fall faster and arrive at the bottom of the column before the slower-falling smaller particles. To distinguish between these differently sized particles in accordance with another aspect of the invention, differentiation or size recognition equipment 90 can be provided, as suggested in FIG. 5. In the illustrated embodiment, this particle size indicating and recognition equipment 90 takes the form of a laser 91 mounted to direct a beam of light 92 through windows 93 and 94 in the cryogenic chamber. Light which illuminates the particles falls on a target screen 95. The laser should provide light at a frequency far from that absorbed by the superfluid so that the heat load on the superfluid helium is minimized. For example, a Nd:YAG laser operating on a low duty cycle at the 532 nm line may be effective. As the particles fall through the laser light beam, diffraction patterns are created on the receiving screen 95. Differently sized particles create differing diffraction patterns. Differences in the diffraction patterns can be detected and sensed by a computer 96 connected to the target screen 95, and information about the particles sizes can be delivered to the system operator by any suitable means.

This information about particles sizes can be used to harvest particles of a desired size or sizes and to discard particles which are excessively large or excessively small. This particle harvesting can be accomplished in any of a number of ways. For example, particles 11 which are too large will reach the bottom of the chamber apparatus first, before any particles of the desired size arrive. Under the circumstances, the superfluid helium in a discard conduit 42 can be pumped out, drawing off the oversized particles 11 with the fluid. Thereafter, when particles of the desired size begin to reach the bottom of the column, discard column pumping is halted and the superfluid helium and right-sized particles can be drawn-off from the column 40 by a harvest conduit 44 and pump (not shown). When particles 13 which are too small to meet requirements begin to arrive at the bottom of the column 40, pumping and particle draw off or removal through the harvest column 44 can be halted and particle withdrawal through the discard column 42 can be resumed.

Alternatively, a diverter baffle 47 can be located at the column bottom as illustrated in FIG. 5, and the diverter baffle 47 can be connected by a shaft or any other suitable means 48 to a baffle control 49 as illustrated in FIGS. 4 and 5. The diverter baffle is oriented, sized and located to direct particles falling upon it to either a discard portion 48 of the column bottom or to a harvest or collection portion 49 of the column bottom. The operation of this diverter baffle can be controlled by the particle size sensing computer 97.

1. A device for separating very small particles by size, comprising, in combination,
a cryogenic chamber within which particle travel and separation can occur,
a loading chamber connected to the cryogenic chamber for loading particles into the cryogenic chamber, and
a collector device connected to the cryogenic chamber for collecting at least some of the particles after they have been separated by size.

2. A device according to claim 1 further including a device for indicating the size of the particles as the particles move through the cryogenic chamber.

3. A device according to claim 1 wherein said cryogenic chamber is adapted to produce and maintain a column of very low viscosity, high wetting fluid.

4. A device according to claim 1 further including a superfluid within said cryogenic chamber.

5. A device according to claim 4 wherein said superfluid is a liquid.

6. A device according to claim 5 wherein said liquid is helium.

7. A device according to claim 6 wherein said helium is 4He.

8. A device according to claim 1 wherein said cryogenic chamber is adapted to produce an internal temperature of lower than 2.2 degrees Kelvin.

9. A device according to claim 1 further including a discard conduit for drawing off particles to be discarded.

10. A device according to claim 1 further including a harvest conduit for drawing off particles to be harvested.

11. A device according to claim 1 further including a discard conduit for drawing off particles to be discarded, a harvest conduit for drawing off particles to be harvested, and an actuator for actuating a flow of fluid in the discard conduit and a flow of fluid in the harvest conduit at different times.

12. A device according to claim 1 wherein said loading chamber includes a receiver for receiving the particles to be separated and for loading the particles into said cryogenic chamber.

13. A device according to claim 12 further including a gate valve interposed between said receiver and said cryogenic chamber for controlling the flow of particles from the loading chamber to the cryogenic chamber.

14. A device according to claim 12 wherein said loading chamber further includes a vacuum conduit for drawing air from the receiver.

15. A device according to claim 12 wherein said loading chamber further includes a delivery conduit for delivering helium to the receiver.

16. A device according to claim 13 further including a delivery conduit extending from the receiver into the cryogenic chamber by a sufficient distance that the particles flowing from the receiver and the gate valve are deposited within superfluid in the cryogenic chamber.

17. A device according to claim 1 wherein said collector device includes a diverter for diverting a flow of particles to be discarded from a flow of particles to be harvested.

18. A device according to claim 1 further including a laser generator positioned to direct a beam of laser light through the cryogenic chamber so as to illuminate any particles therein.

19. A device according to claim 18 further including a detection device for detecting a diffraction pattern of light created by said illumination of particles within the cryogenic chamber.

20. A device according to claim 19 further including recognition apparatus for detecting and distinguishing between various diffraction patterns of light created by said illumination of particles within the cryogenic chamber, and for generating different signals in response to the detection of different diffraction patterns.

21. A device according to claim 20 further including means connecting the recognition apparatus to a diverter mechanism for diverting a flow of particles of a predetermined sizes from a flow of particles of other sizes.

22. A method of sorting very small particles by size, comprising the steps of providing a column of very low viscosity high wetting fluid, introducing a plurality of particles of various sizes into the fluid in the column, causing the particles to travel through the fluid so as to separate the particles by size, and harvesting the separated particles of desired size.

23. A method according to claim 21 including the steps of causing the particles to travel through the fluid toward at least one collecting point, and harvesting at least some particles at the collecting point.

24. A method according to claim 22 wherein the step of providing a column of very low viscosity high wetting fluid includes the step of providing a superfluid.

25. A method according to claim 22 wherein the step of providing a superfluid includes the step of providing a helium superfluid.

26. A method according to claim 22 further including the steps of illuminating the particles traveling through the fluid, creating diffraction patterns by the illumination of the particles, and distinguishing between particles of different sizes by differences in said diffraction patterns.

27. The method according to claim 22 further including the steps of loading particles into a loading chamber receiver and drawing air from the loading chamber receiver before introducing the particles into the cryogenic chamber.

28. The method according to claim 27 further including the steps of introducing gaseous helium into the loading chamber receiver after at least some air is drawn from the loading chamber receiver.

29. A method according to claim 22 further including the step of drawing particles to be harvested from the cryogenic chamber.

30. A method according to claim 22 further including the step of drawing particles to be discarded from the cryogenic chamber.

31. A method according to claim 22 further including the steps of drawing particles to be harvested from the cryogenic chamber at a predetermined time, and drawing particles to be discarded from the cryogenic chamber at a different time.

32. A batch of particles of predetermined sizes which have been selected by the method of claim 31.

33. A batch of particles wetted by helium.

34. A superfluid having therein a plurality of very small particles.

35. A combination according to claim 34 wherein at least some of said particles are less than 40 microns in size.

36. A combination according to claim 34 wherein at least some of said particles are less than 2 microns in size.

37. A combination according to claim 33 wherein said helium is in a superfluid state.

38. A combination according to claim 33 wherein said helium has a temperature of less than 2.2 degrees Kelvin.

39. A combination according to claim 34 wherein said superfluid is contained in a vertically elongated chamber.

40. The use of a superfluid helium to separate and sort particles.

41. The use according to claim 40 wherein said superfluity is helium.

42. The use of helium to separate and sort particles.
